(19) United States
(12) Patent Application Publication
(10) Pub. No.: US 2005/0128552 A1
(43) Pub. Date: Jun. 16, 2005

(54) Torsional vibrator, optical deflector and image forming apparatus

(75) Inventors: Susumu Yasuda, Machida-shi (JP); Yasuhiro Shimada, Sagamihara-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/004,983

(22) Filed: Dec. 7, 2004

(30) Foreign Application Priority Data
Dec. 16, 2003 (JP) 2003-417977

(51) Int. Cl. G02B 26/08

(52) U.S. Cl. 359/223; 359/872

(57) ABSTRACT

A resonance type torsional vibrator capable of switching to an object driving frequency is provided, which comprises a frequency switching means capable of switching an excitation frequency between at least two levels.

### BACKGROUND OF THE INVENTION

1. Field of the Invention

The present invention relates to an optical deflector, which is fabricated by using the MEMS (Micro Electro Mechanical Systems) technology, and moreover, it relates to an image forming apparatus using this optical deflector.

2. Related Background Art

In an optical deflector having a mirror portion, in order to obtain a large deflection angle by a small power consumption, there is generally utilized a resonance phenomenon of a structural member having a mirror portion and an elastic support member for supporting the mirror portion. As an example of the optical deflector for making this resonance frequency variable, there is known an optical deflector disclosed in Japanese Patent Application Laid-Open No. 2002-202474.

FIG. 8 is a schematic view explaining the optical deflector of a frequency variable type disclosed in the above patent document. This optical deflector comprises a mirror portion 1002, a pair of elastic support beams 1003 integrally formed with the mirror portion 1002 along an oscillation axis which passes through a center of gravity of the mirror portion 1002, a substrate 1005 for holding the pair of elastic support beams 1003, and a drive means 1015 for oscillating the mirror portion 1002. An excitation frequency generation means 1018 provides an excitation frequency to the drive means 1015, and moreover, the frequency thereof is compared with an output of a resonance frequency detection means 1019 for detecting the resonance frequency of the mirror potion 1002 by a comparator 1017. Further, a control means 1016, by using a beam binding means 1007, varies the binding state of the pair of elastic support beams 1003 to vary an intrinsic elastic constant of the elastic support beams 1003, and performs a control in such a way that the output of the comparator 1017 becomes zero. In this manner, at an arbitrary frequency generated by the excitation frequency generation means 1018, the mirror portion 1002 can mechanically be driven in a resonance state.

The present invention is to solve the following problems in relation to the optical deflector of the frequency variable type.

The structure is complicated and the production cost thereof is high.

A separate frequency-varying mechanism other than a drive mechanism is required, and therefore, the power consumption is large.

A friction loss is generated in the binding means and the elastic support beams, so that the Q value of resonance is lowered.

Wear is generated in the binding means and the elastic support beams so that change in the resonance characteristics with time is generated.

### SUMMARY OF THE INVENTION

The present invention has been accomplished to solve the above-described problems, and a first aspect of the present invention is a torsional vibrator, comprising:
a plurality of torsion springs and a plurality of vibrators alternatively connected, torsional axes of all the plurality of torsion springs being arranged in the same straight line and an end portion of at least one of the plurality of torsion springs being fixed to a fixing portion;
an excitation (or driving) means for imparting a torsional vibration to at least one of the plurality of vibrators; and
a frequency switching means for switching an excitation frequency of the excitation means between at least two levels,
wherein the vibrator vibrates resonantly at the at least two levels of frequencies by being imparted with the torsional vibration.

In the present invention, it is preferable that the excitation means is an electrostatic actuator.

Further, it is preferable that the excitation means is an electromagnetic actuator.

Moreover, it is preferable that the excitation means is a piezoelectric actuator.

Further, a second aspect of the present invention is an optical deflector comprising the above-mentioned torsional vibrator wherein at least one of the plurality of vibrators has a light deflecting means.

Moreover, a third aspect of the present invention is an image forming apparatus comprising a light source, a light source modulating means for modulating the light source, the above-mentioned optical deflector, and a control means for controlling the light source modulating means and the optical deflector.

According to the present invention, because a complicated frequency-switching mechanism is not used, a frequency variable torsional vibrator and a resonance type optical deflector can be provided.

Further, because a separate frequency-varying mechanism other than a drive mechanism is not required, the power consumption can be reduced.

Moreover, because a binding means is not required, the friction loss is reduced and the Q value of resonance can be made high, thereby reducing the power consumption.

Further, because there exists no wearing portion, the change in the resonance characteristics with time can be reduced.

Moreover, by using the resonance type optical deflector of the present invention, a light scanning display capable of switching a scanning frequency can be provided.

### BRIEF DESCRIPTION OF THE DRAWINGS

FIG. 1 is a view explaining a resonance type optical deflector of Example 1;

FIGS. 2A and 2B are views explaining a vibration mode of the resonance type optical deflector of Example 1;

FIG. 3 is a view explaining a principle of operation of the present invention;

FIGS. 4A and 4B are views explaining a principle of operation of the present invention;

FIG. 5 is a view explaining a resonance type optical deflector of Example 2;

FIGS. 6A, 6B and 6C are views explaining a vibration mode of the resonance type optical deflector of Example 2;

FIG. 7 is a view explaining a light scanning display of Example 3; and

FIG. 8 is a view explaining a conventional resonance frequency variable type optical deflector.

### DESCRIPTION OF THE PREFERRED EMBODIMENTS

First, reference numerals shown in the figures will be described.

Reference numeral 004 denotes a fixing portion, reference numerals 011 and 012 a torsional vibrator, reference numeral 021 and 022 a torsion spring, reference numeral 050 an excitation means, reference numeral 104 a fixing frame, reference numerals 111 to 112 a vibrator, reference numerals 121 to 124 a torsion spring, reference numeral 150 an excitation means, reference numeral 204 a fixing frame, reference numerals 211 to 215 a torsional vibrator, reference numerals 221 to 226 a torsion spring, reference numeral 301 a resonance type optical deflector, reference numeral 302 an optical deflector, reference numeral 303 a laser light source, reference numeral 304 a control means, reference numeral 310 a laser light, and reference numeral 320 a screen.

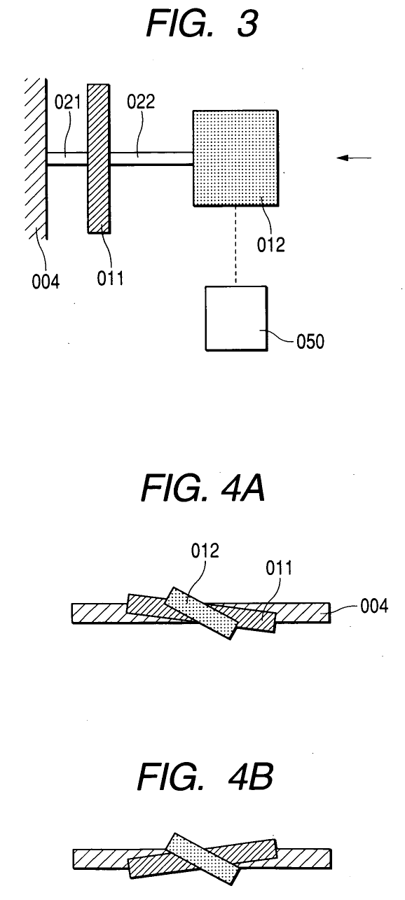

A principle of operation of the resonance type vibrator of the present invention will be described. FIG. 3 is a schematic view of the resonance type vibrator of the present invention. A torsion spring 021, a torsional vibrator 011, a torsion spring 022, and a torsional vibrator 012 are connected in the mentioned order on the same axis, and the torsion spring 021 is connected to a fixing portion 004.

Where the moment of inertial about axis and the displacement angle of the vibrators 011 and 012 are represented by I₁, θ₁, I₂, and θ₂, respectively, and the spring constants of the torsion springs 021 and 022 are represented by k₁ and k₂, and a damping term is disregarded, the dynamic equation of the vibrator 011 and the torsional vibrator 012 can be given as follows.

$$\begin{matrix}( \begin{matrix}{I}_{1} & 0 \\ 0 & {I}_{2}\end{matrix} ) ( \begin{matrix}{\ddot{θ}}_{1} \\ {\ddot{θ}}_{2}\end{matrix} ) + ( \begin{matrix}{k}_{1} + {k}_{2} & - {k}_{2} \\ - {k}_{2} & {k}_{2}\end{matrix} ) ( \begin{matrix}{θ}_{1} \\ {θ}_{2}\end{matrix} ) = ( \begin{matrix}0 \\ 0\end{matrix} ) \\ ( \begin{matrix}{\ddot{θ}}_{1} \\ {\ddot{θ}}_{2}\end{matrix} ) = - {( \begin{matrix}{I}_{1} & 0 \\ 0 & {I}_{2}\end{matrix} )}^{- 1} ( \begin{matrix}{k}_{1} + {k}_{2} & - {k}_{2} \\ - {k}_{2} & {k}_{2}\end{matrix} ) ( \begin{matrix}{θ}_{1} \\ {θ}_{2}\end{matrix} ) = M ( \begin{matrix}{θ}_{1} \\ {θ}_{2}\end{matrix} ) \\ M = - {( \begin{matrix}{I}_{1} & 0 \\ 0 & {I}_{2}\end{matrix} )}^{- 1} ( \begin{matrix}{k}_{1} + {k}_{2} & - {k}_{2} \\ - {k}_{2} & {k}_{2}\end{matrix} )\end{matrix}$$

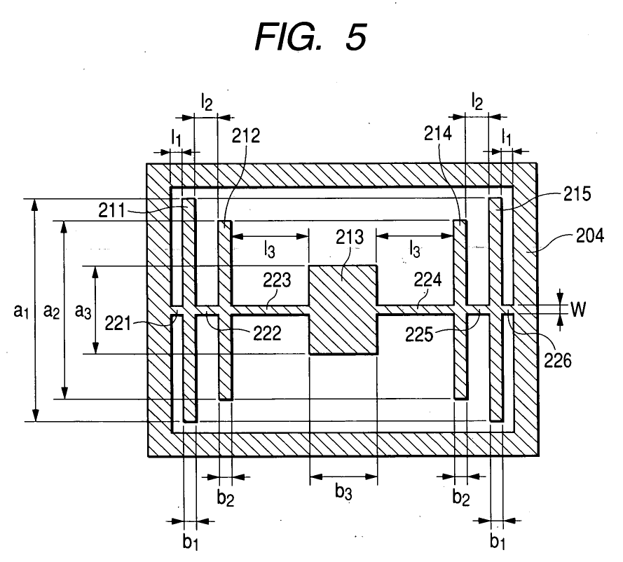

At this time, the eigenvalue and the eigenvector of M represent a square of an angular frequency ω and a vibration mode, respectively. Here, by appropriately designing the motion of inertia and the spring constant, it is possible to set the eigenvalue to a desired value. The state of this resonant vibration is shown in FIGS. 4A and 4B. FIGS. 4A and 4B are views showing the state of vibration of the vibrator when observed in the direction of the arrow in FIG. 3. In this example, there exist two modes including mode 1 (FIG. 4A) of vibrating with θ₁ and θ₂ being in phase, and a mode 2 (FIG. 4B) of vibrating with θ₁ and θ₂ being in opposite phase.

Further, as is easily seen, the number of vibration modes can be increased to two or more by additionally connecting vibrators and torsion springs.

Moreover, by giving a driving torque at a driving frequency approximately equal to any one of these resonance modes by the excitation means 050, the torsional vibrator can be driven resonantly. By switching this resonance frequency, the driving frequency of the torsional vibrator can be selected.

Further, by providing an optical deflector component on at least one of the torsional vibrators, a resonance type optical deflector can be attained.

Moreover, by using the resonance type optical deflector of the present invention, a light scanning display capable of switching a scanning frequency can be provided.

### EXAMPLE 1

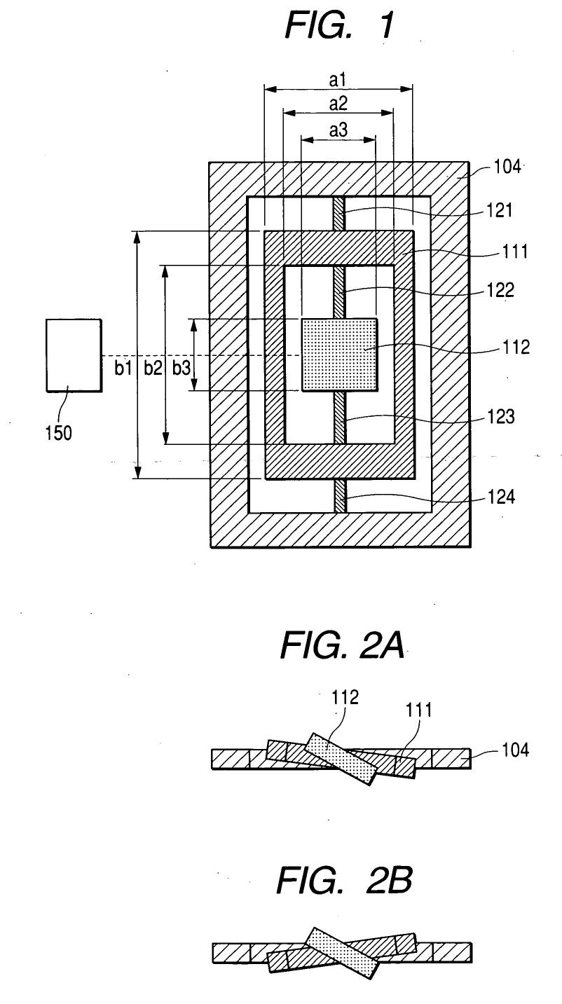

FIG. 1 is a plan view showing a resonance type light scanner of Example 1. A frame shaped vibrator 111 is connected to a fixing frame 104 via torsion springs 121 and 124, and a vibrator 112 is connected to the inner side of the vibrator 111 via torsion springs 122 and 123. In this case, a configuration is adopted such that the torsional axes of the torsion springs 121, 122, 123, and 124 are in line with the principal axes of inertial of the vibrators 111 and 112, and these are formed integrally by etching a silicon wafer. On a surface of the vibrator 112 is formed a light deflecting layer. The excitation means 150 imparts a driving torque to the vibrators 111 and 112. Specifically, examples of the excitation means include an electrostatic actuator using opposing electrodes, an electromagnetic actuator using an electromagnetic force which acts on a magnetic substance, a stacked piezoelectric element, and the like. Further, they may be vacuum-sealed to increase the Q value of resonance, thereby reducing the power consumption.

The sizes of the vibrators 111 and 112 of the present example shown in FIG. 1 are a1=2400 μm, a2=1600 μm, a3=1200 μm, b1=3800 μm, b2=3000 μm, and b3=1000 μm. Where the thickness t of the silicon wafer is 150 μm, and the density ρ thereof is 2330 kgm⁻³, then the moments of inertial about torsional axis I₁ and I₂ become I₁=1.175×10⁻¹² [kgm²], and I₂=5.111×10⁻¹⁴ [kgm²]. Where the spring constants k₁ and k₂ of the torsion of the torsion springs 121 and 122 are k₁=2.123×10⁻² [Nm/rad], and k_{2=1.156}×10⁻³ [Nm/rad], then

$$M = ( \begin{matrix}1.905 \times {10}^{10} & - 9.838 \times {10}^{8} \\ - 2.262 \times {10}^{10} & 2.262 \times {10}^{10}\end{matrix} )$$

is established, and therefore, the eigenvalues and eigenvectors of M become as follow.

$$\begin{matrix}{λ}_{1} = 1.579 \times {10}^{10} , & & {v}_{1} = ( \begin{matrix}0.3018 \\ 1\end{matrix} ) \\ {λ}_{2} = 2.587 \times {10}^{10} , & & {v}_{2} = ( \begin{matrix}- 0.1441 \\ 1\end{matrix} )\end{matrix}$$

Because an eigenvalue is a square of an angular frequency, resonance frequencies f1 and f2 become as follow.
f₁=\sqrt{λ₁}/2π=20.0×10³
f₂=\sqrt{λ₂}/2π=25.6×10³

That is, this resonance type mirror has two vibration modes of 20.0 kHz and 25.6 kHz. When resonating at 20.0 kHz, the amplitude angle of the vibrator 111 is 0.3018 times that of the mirror 112, and the vibrator 111 and the mirror 112 vibrate in phase, and when resonating at 25.6 kHz, the amplitude angle of the vibrator 111 is 0.1441 times that of the mirror 112, and the vibrator ill and the mirror 112 vibrate in opposite phase.

These two resonance frequencies are allowed to correspond to, for example, two display modes of SVGA (800×600 pixels) and XGA (1024×768 pixels) in a luster scanning display. That is, the resonance type optical deflector of the present example can be used while switching two vibration modes of the SVGA display and the XGA display.

As described above, according to the present invention, a frequency variable, resonance type optical deflector can be provided without using a complicated frequency-switching mechanism.

Further, because a separate frequency-varying mechanism other than a driving mechanism is not required, the power consumption can be reduced.

Moreover, because a binding means is not required, the friction loss is reduced and the Q value of resonance can be increased, thereby reducing the power consumption.

Further, because there exists no wearing portion, the change in the resonance characteristics can be reduced.

### EXAMPLE 2

FIG. 5 is a view explaining an optical deflector of Example 2 of the present invention. A fixing frame 204, torsional vibrators 211, 212, 213, 214, and 215, and torsion springs 221, 222, 223, 224, 225, and 226 are made integrally by etching a silicon wafer. The torsional vibrators 211 to 215 and the torsion springs 221 to 226 are connected in the order as shown in FIG. 5, and the torsion springs 221 and 226 are connected to the fixing frame 204. Further, on the central torsional vibrator 213 is formed a light reflecting surface. Further, excitation is effected by a means similar to that of Example 1.

The sizes of the torsional vibrators 211 to 215 are a₁=4000 μm, b₁=200 μm, a₂=3000 μm, b₂=200 μm, a₃=1200 μm, and b₃=1000 μm.

The sizes of torsion springs 221 to 226 are I₁=100 μm, I₂=200 μm, I₃=1000 μm, and w=50 μm.

Assuming that the density and the shear modulus of the silicon material used are 2330 kgm⁻³ and 65 Gpa respectively and the thickness of the silicon wafer is 150 μm, the moments of inertia about axis I¹ to I⁵ of the torsional vibrators 211 to 215 are I₁=3.733×10⁻¹³ [kgm²], I₂=1.577×10⁻¹³ [kgm²], I₃=5.111×10⁻¹⁴ [kgm²], I₄=1.577×10⁻¹³ [kgm²], and 15=3.733×10⁻¹³ [kgm²], and the spring constants k₁ to k₆ of the torsion springs 221 to 226 become k₁=3.209×10⁻³ [Nm/rad], k₂=1.604×10⁻³ [Nm/rad], k₃=3.209×10⁻⁴ [Nm/rad], k₄=3.209×10⁻⁴ [Nm/rad], k₅=1.604×10⁻³ [Nm/rad], and k₆=3.209×10⁻³ [Nm/rad]. Then,

$$\begin{matrix}M = {( \begin{matrix}{I}_{1} & & & & \\ & {I}_{2} & & & \\ & & {I}_{3} & & \\ & & & {I}_{4} & \\ & & & & {I}_{5}\end{matrix} )}^{- 1} ( \begin{matrix}{k}_{1} + {k}_{2} & - {k}_{2} & & & \\ - {k}_{2} & {k}_{2} + {k}_{3} & - {k}_{3} & & \\ & - {k}_{3} & {k}_{3} + {k}_{4} & - {k}_{4} & \\ & & - {k}_{4} & {k}_{4} + {k}_{5} & - {k}_{5} \\ & & & - {k}_{5} & {k}_{5} + {k}_{6}\end{matrix} ) = \\ ( \begin{matrix}4.018 \times {10}^{9} & - 1.339 \times {10}^{9} & & & \\ - 3.171 \times {10}^{9} & 3.805 \times {10}^{9} & - 6.342 \times {10}^{8} & & \\ & - 1.956 \times {10}^{9} & 3.913 \times {10}^{9} & - 1.956 \times {10}^{9} & \\ & & - 6.342 \times {10}^{8} & 3.805 \times {10}^{9} & - 3.171 \times {10}^{9} \\ & & & - 1.339 \times {10}^{9} & 4.018 \times {10}^{9}\end{matrix} )\end{matrix}$$

is established, and since the eigenvalues λ₁₋₅ of M are λ₁=4.160×10⁹, λ₂=5.930×10⁹, λ₃=1.268×10¹⁰, λ₄=1.917×10¹⁰, and λ₅=2.082×10¹⁰, the resonance frequencies are f₁=10.26×10³ [Hz], f₂=12.26×10³ [Hz], f₃=17.92×10³ [Hz], f₄=22.04×10³ [Hz], and f₅=22.96×10³ [Hz].

Further, the eigenvectors v₁₋₅ are given by

$$\begin{matrix}{v}_{1} = ( \begin{matrix}1 \\ 2.032 \\ 3.039 \\ 2.032 \\ 1\end{matrix} ) , & {v}_{2} = ( \begin{matrix}- 1 \\ - 1.620 \\ 0 \\ 1.620 \\ 1\end{matrix} ) , & {v}_{3} = ( \begin{matrix}1 \\ 0.0496 \\ - 5.011 \\ 0.0496 \\ 1\end{matrix} ) , \\ {v}_{4} = ( \begin{matrix}- 1 \\ 1.461 \\ 0 \\ - 1.461 \\ 1\end{matrix} ) , & {v}_{5} = ( \begin{matrix}1 \\ - 1.844 \\ 2.802 \\ - 1.844 \\ 1\end{matrix} ) & \end{matrix}$$

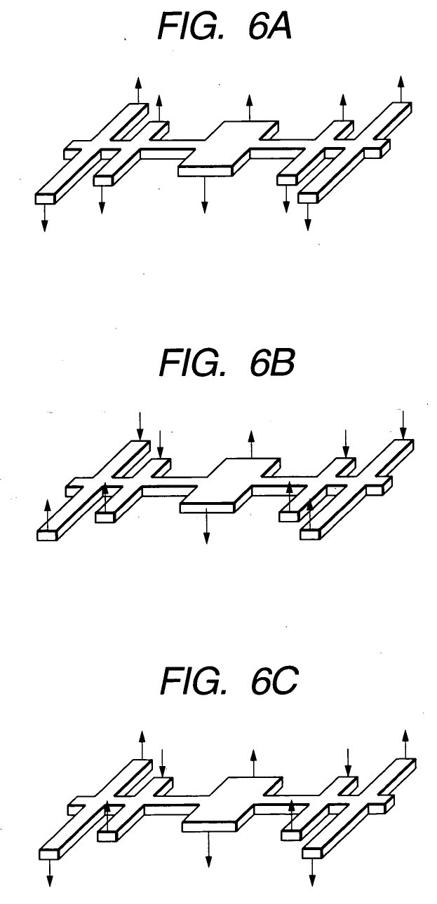

Of these five vibration modes, the mode that can be used for optical scanning is those modes in which the central torsional vibrator 213 is displaced, i.e., v1, v3 and v5. The state of vibration at this time is shown in FIGS. 6A, 6B and 6C. The FIGS. 6A, 6B and 6C correspond to v1, v3 and v5, respectively.

Hence, by exciting the torsional vibrators 211 to 215 by the excitation means at frequencies approximately close to the frequencies of f₁=10.26×10³ [Hz], f₃=17.92×10³ [Hz], and f₅=22.96×10³ [Hz], resonance oscillation can be effected at these frequencies.

As described above, according to the present invention, a frequency variable, resonance type optical deflector can be provided without using a complicated frequency-switching mechanism.

Further, because a separate frequency-varying mechanism other than a drive mechanism is not required, the power consumption can be reduced.

Further, because a binding means is not required, the friction loss is reduced and the Q value of resonance can be made high, thereby reducing the power consumption.

Further, because there exists no wearing portion, the change in the resonance characteristics with time can be reduced.

### EXAMPLE 3

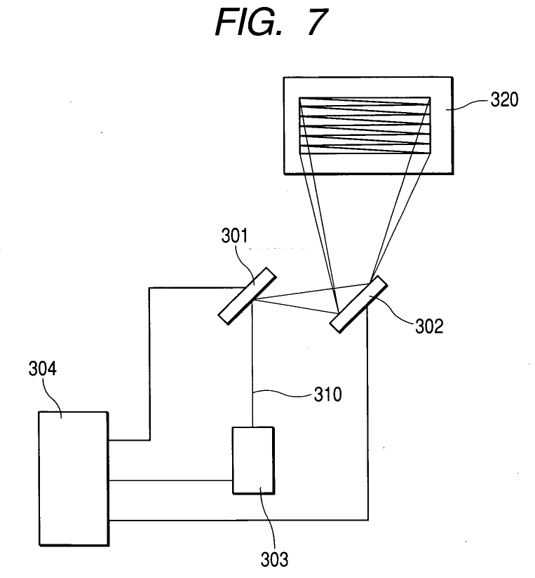

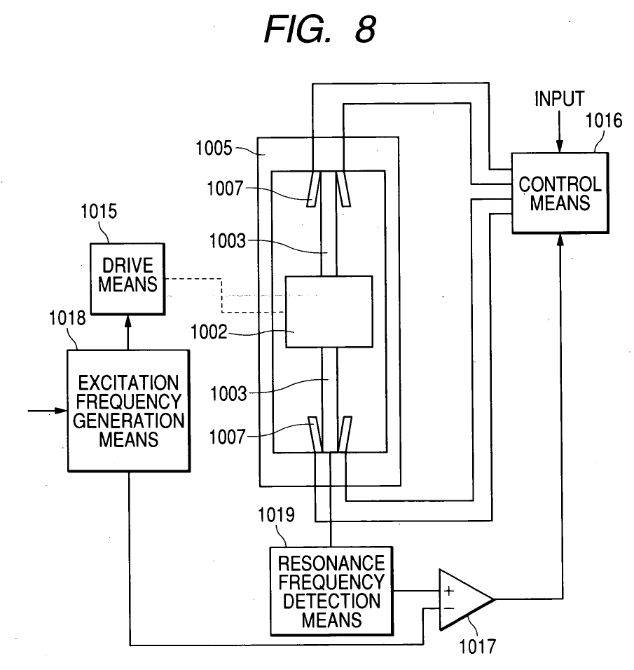

FIG. 7 is a schematic view for explaining a light scanning display in accordance with the present invention. A laser light 310 emitted from a laser light source 303 is scanned in a horizontal direction by a resonance type optical deflector 301 of the present invention, is then scanned in a vertical direction by an optical deflector 302 such as a galvano mirror and the like, and forms an image on a screen 320. The resonance type optical deflector 301, the optical deflector 302 and the laser light source 303 are controlled by a control means 304.

By using the resonance type optical deflector of the present invention, the light scanning display of the present invention can easily perform switching of a driving frequency when performing switching of resolution.

This application claims priority from Japanese Patent Application No. 2003-417977 filed on Dec. 16, 2003, which is hereby incorporated by reference herein.

1. A torsional vibrator, comprising:
a plurality of torsion springs and a plurality of vibrators alternatively connected, torsional axes of all the plurality of torsion springs being arranged in the same straight line and an end portion of at least one of the plurality of torsion springs being fixed to a fixing portion;
an excitation means for imparting a torsional vibration to at least one of the plurality of vibrators; and
a frequency switching means for switching an excitation frequency of the excitation means between at least two levels,
wherein the vibrator vibrates resonantly at the at least two levels of frequencies by being imparted with the torsional vibration.

2. The torsional vibrator according to claim 1, wherein the excitation means is an electrostatic actuator.

3. The torsional vibrator according to claim 1, wherein the excitation means is an electromagnetic actuator.

4. The torsional vibrator according to claim 1, wherein the excitation means is a piezoelectric actuator.

5. An optical deflector comprising the torsional vibrator set forth in claim 1, wherein at least one of the plurality of vibrators has a light deflecting means.

6. An image forming apparatus, comprising:
a light source;
a light source modulating means for modulating the light source;
the optical deflector set forth in claim 5; and
a control means for controlling the light source modulating means and the optical deflector.
